(19) United States
(12) Patent Application Publication
(10) Pub. No.: US 2008/0049366 A1
(43) Pub. Date: Feb. 28, 2008

(54) Protection circuit

(75) Inventor: Takahiro Sato, Gunma (JP)

Correspondence Address: MORGAN LEWIS & BOCKIUS LLP, 1111 PENNSYLVANIA AVENUE NW, WASHINGTON, DC, 20004, US

(73) Assignee: Yokowo Co., Ltd.

(21) Appl. No.: 11/878,716

(22) Filed: Jul. 26, 2007

(30) Foreign Application Priority Data
Jul. 27, 2006 (JP) 2006-204790

(51) Int. Cl. H02H 3/20; H01H 83/10

(52) U.S. Cl. 361/86

(57) ABSTRACT

A transistor is coupled to a load so that an input voltage is applied to the load therethrough. A comparator compares a load-side voltage of the transistor with a reference voltage. A control circuit is operable to deactivate the transistor when the comparator detects that the load-side voltage is lower than the reference voltage. A restoring resistor is connected between an emitter and a collector of the transistor in a parallel manner, so that a feeble current flows in the load even when the transistor is deactivated by the control circuit.

### BACKGROUND

This invention relates to a protection circuit for blocking an overcurrent from flowing through a load due to its abnormality, and a protection circuit for passing a current through the load when the load returns to a normal state.

Now referring to FIG. 4, an explanation will be given of an example of the protection circuit for blocking an overcurrent from flowing through a load due to load abnormality such as short-circuiting. In FIG. 4, an input voltage a is applied to a load 10 through the series of an emitter-collector of an NPN transistor Tr1, a current detecting resistor RY, and a switch SW on the load side. The input terminal of the input voltage a is connected to the emitter of a PNP transistor Tr2 through a base current control resistor RB and the collector of the PNP transistor Tr2 is connected to the base of the transistor Tr1. The base of the transistor Tr2 is grounded through the collector-emitter of an NPN transistor Tr3. Further, the voltage on the load side of the current detecting resistor RY is applied to the one input terminal of a comparator c. To the other input terminal of the comparator c, a reference voltage b is applied. The output terminal of the comparator c is connected to the base of the transistor Tr3. Further, a bias voltage appropriately set by dividing the input voltage a by a pull-up resistor R1 and a base bleeder resistor R2, is applied to this output terminal.

In such a configuration, when the switch SW on the load side is closed, the input voltage a is applied to a load 10. Now, if an overcurrent flows due to abnormality such as short-circuiting in the load 10, a large voltage drop occurs at the current detecting resistor RY. The voltage applied to the one input terminal of the comparator c thereby becomes lower than the reference voltage b. The comparator c detects such decrease of the input voltage so that it generates “L” level signal at its output terminal, thereby turning the transistor Tr1 off. As a result, the overcurrent flowing through the load 10 is blocked. Now, the base current control resistor RB is set for e.g. 150Ω so that the transistor Tr1 operates in a saturated range. So, even when the overcurrent flows, the emitter-collector voltage does not become so large.

Japanese Patent Publication No. 63-59718A discloses a technique for continuously passing an overcurrent for a prescribed time period even when the overcurrent flowing through the load is detected and thereafter repeating the ON/OFF switching of the overcurrent. In the technique disclosed in this publication, even when it is detected that the voltage applied to the load has lowered due to the overcurrent flowing through the load, the overcurrent is not immediately blocked, but blocked after a prescribed time period elapses. In this manner, the current will not be blocked due to an inrush current flowing into a capacitor of a voltage ripple filter and other circuit components.

In the configuration shown in FIG. 4, when the overcurrent is once detected due to the abnormality of the load 10 so that the transistor Tr1 is turned off, the transistor Tr1 is not turned on again even if the load 10 is returned to a normal state. Thus, in a case where an external noise is superposed on the input voltage a so that the input voltage a is instantaneously lowered to turn off the transistor Tr1, the transistor Tr1 is not turned on again, even if the external noise is dissipated to return the input voltage a to a normal state. Further, in the configuration shown in FIG. 4, even under an abnormal state such as the short-circuiting of the load, the overcurrent is intermittently supplied. Accordingly, in a case where a power source is a battery, there is a drawback in that the battery is severely consumed.

### SUMMARY

It is therefore one advantageous aspect of the invention to provide a protection circuit in which a transistor interrupts an overcurrent due to an abnormal state of a load such as short-circuiting or due to abnormal drop of an input voltage of the transistor, and the transistor can resume supplying current whenever the load returns to a normal state.

According to one aspect of the invention, there is provided a protection circuit, comprising:

a load;

a transistor, coupled to the load so that an input voltage is applied to the load therethrough;

a comparator, comparing a load-side voltage of the transistor with a reference voltage;

a control circuit, operable to deactivate the transistor when the comparator detects that the load-side voltage is lower than the reference voltage; and

a restoring resistor, connected between an emitter and a collector of the transistor in a parallel manner, so that a feeble current flows in the load even when the transistor is deactivated by the control circuit.

With this configuration, when the overcurrent is supplied to the load due to the abnormality such as the short-circuiting of the load, voltage drop due to the current detecting resistor is increased. This is detected by the comparator so that the transistor is turned off and the overcurrent is immediately interrupted. Then, when the load is returned to a normal state, the voltage in the load side is made to be higher than the reference voltage through the restoring resistor so that the transistor is turned on again.

The load may be a motor control circuit operable to control a drive mode of a motor.

The load may be a circuit including a voltage ripple filter capacitor.

### BRIEF DESCRIPTION OF THE DRAWINGS

FIG. 1 is a circuit diagram showing a protection circuit according to a first embodiment of the invention.

FIG. 2 is a circuit diagram showing a protection circuit according to a second embodiment of the invention.

FIG. 3 is a circuit diagram showing a protection circuit according to a third embodiment of the invention.

FIG. 4 is a circuit diagram showing a related-art protection circuit.

### DETAILED DESCRIPTION OF EXEMPLIFIED EMBODIMENTS

Exemplified embodiments of the invention will be described below in detail with reference to the accompanying drawings. Components similar to those in the related-art shown in FIG. 4 will be designated by the same reference numerals and repetitive explanations for those will be omitted.

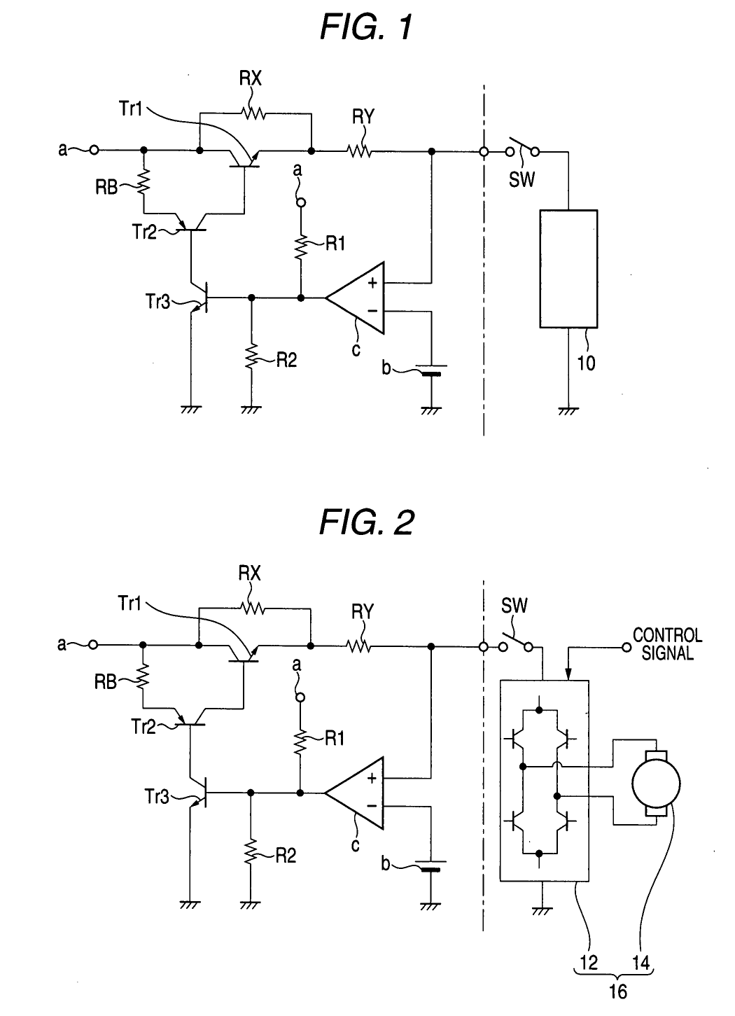

FIG. 1 shows a protection circuit according to a first embodiment of the invention. In this embodiment, a restoring resistor RX is additionally connected in parallel with a part between the emitter and the collector of the transistor Tr1 in the configuration shown in FIG. 4. This restoring resistor RX is set to 100 kΩ as one example. In such a configuration, when an abnormality such as a short-circuiting arises in the load 10 or an input voltage a is instantaneously abnormally lowered, the transistor Tr1 is turned off, which is the same as the circuit of FIG. 4. However, in this embodiment, under a state that the transistor Tr1 is turned off, a feeble current of, for instance, about 1 μA is supplied to the load 10 side through the restoring resistor RX. Thus, when the load 10 is returned to a normal state and the input voltage a is returned to a normal state so that the voltage of the load 10 side is higher than a reference voltage b, the transistor Tr1 is turned on again.

Accordingly, even when the abnormality such as the short-circuiting is temporarily generated in the load 10 so that the transistor Tr1 is turned off, the transistor Tr1 is turned on again whenever the load 10 is returned to the normal state. Further, even if external noise is superposed on the input voltage a so that the input voltage a is temporarily lowered and the transistor Tr1 is turned off, the transistor Tr1 is turned on again, if the external noise is dissipated and the input voltage a is returned to the normal state. Therefore, excellent noise tolerance is obtained.

Next, a second embodiment of the invention will be described with reference to FIG. 2. Components similar to those in the first embodiment will be designated by the same reference numerals and repetitive explanations for those will be omitted.

In this embodiment, to the load side, a motor control circuit 16 serving as the load is connected through the switch SW. This motor control circuit 16 is designed so that a driving circuit 12 composed of electronic components such as transistors appropriately controls rotation of a motor 14 to the forward direction or reverse direction according to a control signal.

In the above-described configuration, when the switch SW of the load side is closed and the motor control circuit 16 as the load operates normally, a voltage of a current detecting resistor RY in the load side is higher than a reference voltage b, so that the on-state of a transistor Tr1 is maintained. However, when, for instance, an external noise is superposed on the control signal so that the driving circuit 12 is abnormally operated and short-circuited, an overcurrent higher than a prescribed current value or more is supplied thereto Thus, the voltage drop of the current detecting resistor RY is increased to a prescribed value and the voltage of the current detecting resistor RY in the load side is lower than the reference voltage b. This state is detected by a comparator c so that the transistor Tr1 is immediately turned off to interrupt the overcurrent. Then, while the transistor Tr1 is kept to be the off-state, a feeble current of, for instance, about 1 μA is supplied to the load side through a restoring resistor RX. Here, when the external noise is dissipated and the driving circuit 12 is returned to a normal state, the voltage of the current detecting resistor RY in the load side becomes high and is higher than the reference voltage b by a current supplied through the restoring resistor RX. Thus, a signal of an output end of the comparator c is inverted to “H” so that the transistor Tr1 is turned on again by the signal. Accordingly, when the load is abnormal, the transistor Tr1 is turned off, and when the load is returned to a normal state, the transistor Tr1 is tuned on. Even when the voltage of an input voltage a is instantaneously lowered due to the external noise or the like so that the voltage of the current detecting resistor RY in the load side is instantaneously lower than the reference voltage b, the transistor Tr1 is also turned on again, if the input voltage a is returned to a normal value.

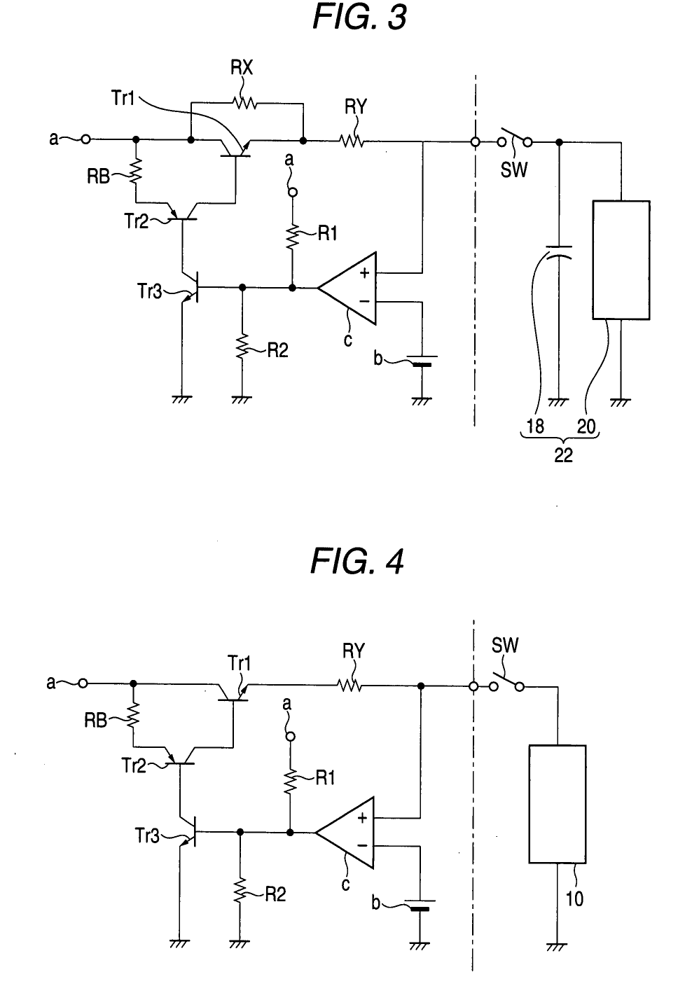

Next, a third embodiment of the invention will be described with reference to FIG. 3. Components similar to those in the first embodiment will be designated by the same reference numerals and repetitive explanations for those will be omitted.

In this embodiment, to a load side, an electronic circuit 22 as the load, is connected through a switch SW, that has a voltage ripple filter capacitor 18 and an amplifying circuit 20 connected in parallel with each other. The voltage ripple filter capacitor 18 has a relatively large capacitance. When the switch SW is closed, a large rush current flows into the voltage ripple filter capacitor 18. Then, the voltage drop of a current detecting resistor RY becomes large. This is detected by a comparator c so that a transistor Tr1 is immediately turned off. However, since a feeble current is supplied to the load side through a restoring resistor RX, the voltage ripple filter capacitor 18 is gradually charged and the voltage of the current detecting resistor RY in the load side becomes gradually high. When the comparator c detects that the voltage of the current detecting resistor RY in the loads side exceeds a reference voltage b, the transistor Tr1 is turned on again. Accordingly, even in a case where the voltage ripple filter capacitor 18 with a large capacitance is included in the load side, this embodiment effectively avoids an inconvenience that the off-state of the transistor Tr1 is maintained. A circuit connected in parallel with the voltage ripple filter capacitor 18 is not limited to the amplifying circuit 20 and it is to be easily understood that any of circuits requiring a filtered input voltage such as an oscillating circuit may be used.

In the embodiments described above, the transistors Tr1 and Tr2 are connected in a Darlington connection, but without being limited to such a connection, the collector of the transistor Tr3 may be directly connected to the base of the transistor Tr1. Further, the transistor Tr1 should not be limited to an NPN type but may be a PNP type. It is needless to say that the connecting position of the base current control resistor RB and others may be appropriately changed according to such a circuit configuration.

Although only some exemplary embodiments of the invention have been described in detail above, those skilled in the art will readily appreciated that many modifications are possible in the exemplary embodiments without materially departing from the novel teachings and advantages of the invention. Accordingly, all such modifications are intended to be included within the scope of the invention.

The disclosure of Japanese Patent Application No. 2006-204790 filed Jul. 27, 2006 including specification, drawings and claims is incorporated herein by reference in its entirety.

What is claimed is:

1. A protection circuit, comprising:
a load;
a transistor, coupled to the load so that an input voltage is applied to the load therethrough;
a comparator, comparing a load-side voltage of the transistor with a reference voltage;
a control circuit, operable to deactivate the transistor when the comparator detects that the load-side voltage is lower than the reference voltage; and
a restoring resistor, connected between an emitter and a collector of the transistor in a parallel manner, so that a feeble current flows in the load even when the transistor is deactivated by the control circuit.

2. The protection circuit as set forth in claim 1, wherein:
the load is a motor control circuit operable to control a drive mode of a motor.

3. The protection circuit as set forth in claim 1, wherein:
the load is a circuit including a voltage ripple filter capacitor.
